(19) United States
(12) Patent Application Publication
(10) Pub. No.: US 2011/0114275 A1
(43) Pub. Date: May 19, 2011

(54) RESIN PRECURSOR

(75) Inventor: Marek Gorzynski, Duren (DE)

(73) Assignee: AKZO NOBEL N.V.

(21) Appl. No.: 13/001,760

(22) PCT Filed: Jun. 29, 2009
(86) PCT No.: PCT/EP09/58114

§ 371 Date: Dec. 28, 2010

(30) Foreign Application Priority Data
Jul. 1, 2008 (EP) 08159404.6
Jul. 1, 2008 (US) 61077296

(51) Int. Cl. D21H 17/52; C08G 73/06; C08L 63/00

(52) U.S. Cl. 162/164.3; 528/327; 523/400

(57) ABSTRACT

The invention relates to a polyamine-epihalohydrin resin precursor comprising N-halo-hydrin groups attached to a polyamine backbone, and 3-hydroxyazetidinium groups attached to a polyamine backbone, said resin precursor having a solids content in the range of from 25 to 95 wt. % and a molar ratio of N-halohydrin groups to 3-hydroxyazetidinium groups in the range of from 1:2 to 100:1, as determined by ¹³C-NMR. The invention also relates to a process for producing the polyamine-epihalohydrin resin precursor, a process for producing a composition comprising a polyamine-epihalohydrin resin, and a process for the production of paper.

### FIELD OF THE INVENTION

The present invention relates to polyamine-epihalohydrin resin precursors, production thereof, a process for the production of a polyamine-epihalohydrin resin and a process for the production of paper.

### BACKGROUND OF THE INVENTION

Aqueous solutions of polyamine-epihalohydrin resins are widely used in papermaking in order to impart wet strength properties to paper. Resins of this type are usually prepared by reacting epichlorohydrin with polyamine polymers such as polyaminoamides and polyalkylene polyamines. However, the preparation of these resins is associated with problems due to the nature and properties of epichlorohydrin, such as its reactivity and toxicity. The handling of epichlorohydrin requires extensive and rigorous safety measures, additional equipment and control devices in the chemical plant.

Despite the problems associated with the handling of epichlorohydrin, polyamine-epichlorohydrin resins are produced in a large number of chemical plants throughout the world. One reason for this is that the resin solutions exhibit limited stability which makes storage and shipping over long distances difficult or impracticable. The insufficient stability may give rise to extensive cross-linking and gelling of the resin. Therefore, typical wet-strength resins are diluted to less than 30 wt. % dry content for storage and transport, and the pH is adjusted to around 2-4. In many applications, a gelled resin is useless, since it cannot be further diluted with water and therefore cannot be conveniently used, e.g. as a wet-strength agent in paper making.

The prior art describes a large number of methods for preparing polyamine-epihalohydrin, in particular epichlorohydrin resins. For example, U.S. Pat. No. 3,891,589 discloses a process for preparing an aqueous solution of a cationic thermosetting resin by reacting a polyamide polyamine with epichlorohydrin. High stability at high solid content is said to be obtained by conducting the reactions under controlled concentration ranges, reaction time and temperatures, and molecular weight values.

EP 0 320 121 describes a process for stabilising an aqueous solution of a polyamine-epichlorohydrin resin solution. High stability at a solid content of between about 15 and 30 wt. % is said to be obtained by the addition of a mixture of a weak acid and a strong acid and by adjustment of the pH into the range from about 3.0 to about 4.2.

However, there is still a problem in providing high performance wet-strength resins having sufficiently high solids content and stability for efficient long distance shipping.

It is an object of the present invention to overcome the above mentioned problems relating to the production and supply of polyamine-epihalohydrin resins. In particular, it is an object of the invention to provide a polyamine-epihalohydrin resin precursor having high storage stability at high solids content. Another object of the present invention is to provide a process for the production of polyamine-epihalohydrin resins by which the handling of epihalohydrin, in particular epichlorohydrin, may be reduced.

### SUMMARY OF THE INVENTION

The present invention is generally directed to a polyamine-epihalohydrin resin precursor comprising, as functional groups:
N-halohydrin groups attached to a polyamine backbone, and
3-hydroxyazetidinium groups attached to a polyamine backbone, said resin precursor having a solids content in the range of from 25 to 95 wt. % and a molar ratio of N-halohydrin groups to 3-hydroxyazetidinium groups in the range of from 1:2 to 100:1.

The present invention is further generally directed to a process for producing a polyamine-epihalohydrin resin precursor comprising the steps of:
(i) reacting a polyamine and epihalohydrin to obtain a reaction product comprising, as functional groups:
   N-halohydrin groups attached to a polyamine backbone, and
   3-hydroxyazetidinium groups attached to a polyamine backbone; and
(ii) adding at least one acid to said reaction product when said reaction product has attained a molar ratio of N-halohydrin groups to 3-hydroxyazetidinium groups in the range of from 1:2 to 100:1.

The present invention is also generally directed to a process for producing a polyamine-epihalohydrin resin comprising adding an alkaline material to a polyamine-epihalohydrin resin precursor according to the invention.

The present invention is further directed to a process for production of paper comprising the steps of
adding an alkaline material to the resin precursor according to the invention to form a polyamine-epihalohydrin resin;
providing a furnish comprising cellulosic fibres;
adding said polyamine-epihalohydrin resin to said furnish; and
forming paper from said furnish.

### DETAILED DESCRIPTION OF THE INVENTION

In accordance with the present invention there is provided a polyamine-epihalohydrin resin precursor which has only poor performance as a wet-strength agent but has high stability, thus allowing long-distance shipping at high concentration without affecting the quality of the product. On the other hand, the precursor can easily be converted to a high performance polyamine-epihalohydrin resin, preferably a polyamine-epichlorohydrin resin. Thus, a precursor may be produced at a central production plant which is well adapted to handling of epichlorohydrin, and may then be transported to production plants located close to their consumer market for subsequent conversion to high performance products without the need for the advanced safety equipment required by the handling of epichlorohydrin. Hence, the number of chemical plants employing large quantities of epichlorohydrin can be reduced, which offers inter alia substantial environmental and safety benefits.

The polyamine-epihalohydrin resin precursor comprising, as functional groups, N-halohydrin and 3-hydroxyazetidinium groups. An N-halohydrin group and a 3-hydroxyazetidinium group may be attached to the same polyamine backbone or to different polyamine backbones. The epihalohydrin used in the process of the invention is preferably epichlorohydrin. Similarly, the N-halohydrin groups of the resin precursor are preferably N-chlorohydrin groups. The counter ions of the 3-hydroxyazetidinium groups of the resin precursor can be halide, preferably chloride, or hydroxide, as the resin precursor is preferably present in an aqueous phase, or a combination thereof. Generally, a higher N-halohydrin content in relation to 3-hydroxy-azetidinium, provides a better stability. However, a higher content of 3-hydroxyazetidinium groups may allow for a faster conversion into the final polyamine-epihalohydrin resin. Preferably, the resin precursor has a molar ratio of N-halohydrin groups to azetidinium groups of at least 1:2, such as at least 1:1.5, at least 1:1 or at least 2:1, and the molar ratio of N-halohydrin groups to azetidinium groups can be up to 100:1, such as up to 15:1, or up to 10:1, up to 8:1 or up to 7:1.

Preferably, the resin precursor has a solids content exceeding 30 wt. %, particularly in the range of from 35 to 90 wt. %, or from more than 50 up to 70 wt. %. It may also be advantageous if the solids content exceeds 55 wt. % or exceeds 60 wt. %.

The resin precursor preferably has a pH in the range of from 3 to 7, for example in the range of from 4 to 6 or from 4.5 to 5.5. The resin precursor has been found to have height stability even at relatively high pH, which allows a reduction of the amount of acid added to achieve acceptable stabilisation and also inhibits hydrolysis of the polyamine backbone which might otherwise result in viscosity decrease or significant crosslinking of the resin and gelling of the product. All pH values herein refer to the pH as measured in an aqueous solution of the resin precursor.

Compared to a conventional wet-strength resin, the resin precursor of the invention has a lower viscosity if measured at the same solids content. Preferably, the resin precursor has a Brookfield viscosity from 5 to 50 mPa:s most preferably from 5 to 25 mPa:s, measured by diluting it with water to a solids content of 21 wt. % and using a micro falling ball Haake viscometer at 25° C. Unless otherwise stated, all values relating to viscosity herein refer to viscosity measured as stated above. Measurements with a micro falling ball in the above viscosity range usually give values not deviating significantly from measurements with a Brookfield viscometer with an ultralow viscosity adaptor.

As used herein, the term “polyamine” is meant to comprise any compound containing at least two amine groups. The amine groups may be primary, secondary or tertiary amine groups, or mixtures thereof. Preferably, the polyamine contains at least one secondary amine group. The polyamine may be a low molecular weight diamine, although oligomeric and polymeric polyamines are preferred. The weight average molecular weight M_{w} of the polyamine is preferably in the range of from 100 to 50,000, most preferably from 500 to 10,000.

Preferably, the polyamine is a polyaminoamide. In the art, a polyaminoamide may also be referred to as a polyamidoamine, polyaminopolyamide, polyamidopolyamine, polyamidepolyamine, polyamide, basic polyamide, cationic polyamide, aminopolyamide, amidopolyamine or polyaminamide. Preferred polyaminoamides are reaction products of at least one polycarboxylic acid, usually dicarboxylic acid, and at least one polyamine. The polycarboxylic acid and the polyamine may, for example, be applied in a mole ratio of from 0.5:1 to 1.5:1 or from 0.7:1 to 1.4:1. Preparation of polyaminoamides can be performed by any method known in the art, e.g. those described in U.S. Pat. No. 5,902,862.

Suitable polyamines include polyalkylene polyamines, or mixtures thereof, satisfying the following formula:

H₂N—(CR¹H)ₐ—(CR²H)_{b}—N(R³)—(CR⁴H)_{c}—(CR⁶H)_{d}—NH₂ (I)

in which R¹-R⁵ represent hydrogen or lower alkyl, preferably up to C₃ and a-d represent integers from 0-4. Preferred polyalkylene polyamines include diethylene triamine, triethylene tetra amine, tetraethylene penta amine, dipropylene triamine, and mixtures thereof. The polyamines of formula I may be combined with other polyamines or mixtures of other amines. Preferably, such amines satisfy the following formulae II-VII.

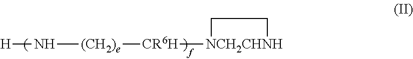

R⁷R⁸N—(—(CH₂)_{g}—CR⁹H—(CH₂)ₕ—N(R¹⁰)—)ᵢ—H (III)

HR¹¹N—(CH₂)ⱼ—CR¹²H—(CH₂)ₖ—OH (IV)

HNR¹³R¹⁴ (V)

H₂N—(CH₂)ₗ—COOH (VI)

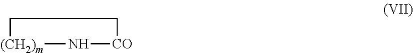

in which R⁶-R¹⁴ represent hydrogen or lower alkyl, preferably up to C₃, e-l represent integers from 0 to 4, and m represents an integer from 1 to 5.

If desired, the polyamines may be used in combination with monoamines, i.e., compounds containing only one amine group (being a primary, secondary or tertiary amine group).

Suitable polycarboxylic acids include aliphatic, saturated or unsaturated, and aromatic dicarboxylic acids. Preferably, the polycarboxylic acid contains less than 10 carbon atoms. For the purpose of the invention, the term “carboxylic acid” is meant to include carboxylic derivatives, such as anhydrides, esters or half esters. Suitable polycarboxylic acids and derivatives thereof include oxalic acid, malonic acid, succinic acid, glutaric acid, adipic acid, azelaic acid, and sebacic acid. Mixtures of these acids can also be applied. A preferred polycarboxylic acid is adipic acid.

The polyamine-epihalohydrin resin precursor according to the invention may be an aqueous composition having a solids content as specified above. In addition to a precursor as described above, the compositions may further comprise unreacted epihalohydrin.

By “high stability”, as used herein, is meant that a composition or a compound does not undergo significant chemical changes. For a conventional polyamine-epihalohydrin resin product, unstability is usually manifested in extensive cross-linking, resulting in drastic viscosity increase and gelling, alternatively hydrolysis and viscosity decrease, both of which makes the product useless. The stability of a polyamine-epihalohydrin resin or resin precursor is usually determined on the basis of change in viscosity over time, measured at the same solids content.

The polyamine-epihalohydrin resin precursor according to the invention may be stored at room temperature without gelling or drastic viscosity changes, for example from about one day up to one week, up to about three weeks, or up to about three months or more without any significant impact on the performance of the final product. A change in up to ±20% of the viscosity measured at a solids content of 21 wt. % does usually not have any negative impact on the performance.

The process according to the invention may be used for preparing a polyamine-epihalohydrin resin precursor as described above. The reaction between the polyamine and the epihalohydrine is preferably performed in an aqueous phase which, for example, may have a solids content from about 30 to about 90 wt. % or from about 35 to about 70 wt. %. At very high solid contents, such as exceeding about 75 wt. %, it may be appropriate to perform the reaction in an extruder or similar equipment providing for high sheer forces.

The polyamine may be reacted with from about 0.1 to about 3 moles of epihalohydrin per mole of amine group in the starting polyamine, preferably with from 0.5 to 1.5 moles and more preferably from 0.8 to 1.2 moles per mole of amine group. Preferably, the molar ratio of epihalohydrin to amine groups is based on secondary amine groups. It may be preferable to use a molar excess of epihalohydrin with respect to the secondary amine groups of the polyamine in order to improve the stability of the final resin product.

Initially, epihalohydrin and polyamine are typically reacted at an alkaline pH, such as a pH of at least 9, for example in the range of from 9 to 14. However, as the reactions proceed, the pH of the polyamine-epihalohydrin reaction product may drop, for example to be from 7 to 9.

The reaction between epihalohydrin and a polyamine involves various specific chemical reactions. Examples of reactions that take place between epihalohydrin and a polyamine containing a secondary amine group, R—NH—R′, include epihalohydrin alkylation of an amine group resulting in the formation of an N-halohydrin group and subsequent conversion of the N-halohydrin group to a 3-hydroxyazetidinium group by a cyclisation reaction. The rate of the cyclisation reaction depends on the reaction conditions used. The cyclisation reaction leads to the conversion of uncharged groups containing organic halogen to cationic groups (quaternary amines) and halide ions. Thus, the content of inorganic halogen is increasing during the course of the reaction. The polyamine-epihalohydrin resin precursor according to the invention has a higher content of N-halohydrin groups in relation to 3-hydroxyazetidinium groups than conventional polyamine-epihalohydrin resins.

Lowering the pH by the acid addition significantly reduces the rate of the reaction in which N-halohydrin groups are converted to 3-hydroxyazetidinium groups. Thus, by quenching the N-halohydrin conversion to 3-hydroxyazetidinium, a resin precursor can be obtained which has improved stability at high solids content compared to conventional resins.

When the polyamine-epihalohydrin reaction product has a molar ratio of N-halohydrin groups to 3-hydroxyazetidinium groups in the desired range as specified above, at least one acid is added to the reaction product in an amount sufficient to reach a suitable pH, preferably from 3 to 7, particularly from 4 to 6 or from 4.5 to 5.5, thus quenching the reaction. Permitting the reaction to proceed to far, e.g. to a molar ratio of N-halohydrin groups to 3-hydroxyazetidinium groups below 1:3, will result in lower stability of the polyamine-epihalohydrin resin precursor.

The at least one acid may be an organic acid and/or an inorganic acid. Preferably, the acid is an organic acid selected from the group consisting of formic acid, acetic acid, para-toluenesulfonic acid, methane sulfonic acid, citric acid, and mixtures thereof. More preferably the acid comprises formic acid. The acid may also be an inorganic acid selected from the group consisting of sulphuric acid, phosphoric acid, nitric acid, sodium hydrogen sulphate, hydrochloric acid, and mixtures thereof. Preferably the inorganic acid is sulphuric acid.

In addition to stabilising the resin precursor by moderating the rate of conversion to 3-hydroxyazetidinium, the acid, in particular when it comprises formic acid, may serve as an environmentally sound biocide in an article in which the resin precursor or a product obtained therefrom is incorporated. Hence, the use of environmentally undesirable biocides may be reduced or avoided.

In an embodiment of the invention, the acid addition is performed in at least two separate steps. In a first step, an acid, for example formic acid, is added to the reaction product for example to achieve a first reduction in pH. After the first acid addition step, the pH may be in the range of from 6 to 7. In a subsequent step, another acid, for example sulphuric acid, may be added to the resin precursor in order to achieve a pH in the desired final range as earlier specified. When the acid addition is performed in two consecutive steps, these steps may be separated by any operation, for example dilution of the resin precursor.

As the inorganic halogen content is increasing during the course of the cyclisation reaction to form a 3-hydroxyazetidinium group, the molar ratio of N-halohydrin groups to 3-hydroxyazetidinium groups of the polyamine-epihalohydrin reaction product may be conveniently estimated by monitoring the inorganic halogen content of the polyamine-epihalohydrin reaction product. For example, the above at least one acid may be added to the reaction product when it has an inorganic halogen content of at most 50 mole % based on total halogen. “Total halogen” is defined as the combined content of organic and inorganic halogen present in the polyamine-epihalohydrin reaction mixture. Preferably, the acid is added when the reaction mixture has an inorganic halogen content of at most 35 mole %, most preferably at most 25 mole % or at most 20 mole %, based on total halogen content. Usually the inorganic halogen content may be at least 5 mole % based on total halogen content. The inorganic halogen content may be determined by conventional methods, for example by titration. The inorganic halogen content of the polyamine-epihalohydrin resin precursor according to the invention is preferably as specified above, although it may increase during storage.

The molar ratio of N-halohydrin to 3-hydroxyazetidinium of the polyamine-epihalohydrin resin precursor and the polyamine-epihalohydrin resin as defined herein is determined by carbon-13 nuclear magnetic resonance (¹³C-NMR) spectroscopy.

Compared to conventional processes, the process for producing a polyamine-epihalohydrin resin precursor according to the invention typically results in reduced formation of organic halogen-containing by-products. For example, when epichlorohydrin is used, the process according to the invention results in very low formation of chloropropanediol (CPD) and dichloro-propanol (DCP), both of which are highly undesirable.

The reaction between epihalohydrin and the polyamine is usually carried out at a temperature in the range of from 0 to 60° C., preferably from 10 to 45° C. and most preferably from 10 to 25° C. An advantage of using a low reaction temperature when reacting the epihalohydrin and the polyamine, such as below 45° C. or particularly below 25° C. is the reduced formation of dichloropropanol (DCP).

A polyamine-epichlorohydrin resin precursor obtained by the process according to the invention may subsequently be subjected to a halogen reducing process, such as a dechlorination process, to further reduce the content of inorganic and/or organic halogen, e.g. chloride ions, CPD and/or DCP. The halogen reducing process may be performed by any known process that is suitable for treating a composition having a high solids content, for example extraction with a supercritical fluid as described in WO 2007/004972.

The polyamine-epihalohydrin resin precursor according to the invention has rather poor wet strength properties, possibly due to the low content of 3-hydroxyazetidinium groups and the relatively low molecular weight of the resin. Thus, by increasing the 3-hydroxyazetidinium content of a resin precursor according to the invention, its wet strength activity may be enhanced. This may be done by increasing the reaction rate of the conversion of N-halohydrin to 3-hydroxyazetidinium in order to allow the reaction to proceed further.

Thus, a further aspect of the invention relates to a process for producing a polyamine-epihalohydrin resin, said process comprising adding an alkaline material to a polyamine-epihalohydrin resin precursor as described above. In most cases a preferably aqueous composition comprising the polyamine-epihalohydrin resin is obtained.

The alkaline material may be any alkaline material conventionally used in the art, comprising both inorganic and organic bases, such as alkali metal hydroxides, carbonates and bicarbonates, alkaline earth metal hydroxides, trialkylamines, tetraalkylammonium hydroxides, ammonia, organic amines, alkali metal sulfides, alkaline earth sulfides, alkali metal alkoxides, alkaline earth alkoxides, and alkali metal phosphates, such as sodium phosphate and potassium phosphate. A preferred alkaline material is sodium hydroxide.

The process may also comprise the step of heating said resin precursor to a temperature in the range of from 40 to 90° C., preferably from 50 to 80° C. or from 55 to 75° C. before and/or after said step of adding an alkaline material. For example, after addition of the alkaline material, the resin precursor may be heated at a rate of from 2 to 5° C./10 minutes until a desired temperature is reached.

Increasing the pH of the polyamine-epihalohydrin resin precursor and optionally heating the resin precursor results in an increase in the rate of N-halohydrin conversion to 3-hydroxyazetidinium. By thus resuming the reaction between the polyamine and epihalohydrin a polyamine-epihalohydrin resin is obtained which has improved wet strength properties compared to the polyamine-epihalohydrin resin precursor.

The conversion process according to the invention may involve diluting the resin precursor, preferably by water, to a desired solids content, e.g. of from about 12.5 to about 35 wt %, before adding an alkaline material thereto. The alkaline material is preferably added in an amount to adjust the pH to a value in the range of from 5.5 to 10, preferably from 5.5 to 9, depending on the pH of the precursor.

The resin precursor is typically allowed to react at the above specified conditions until the resin has the desired properties, for exampled by monitoring the viscosity, the molar ratio of N-halohydrin groups to 3-hydroxyazetidinium groups or the molecular weight. A desired viscosity, measured at a solids content of 21 wt %, is preferably from above 40 up to 250 mPa s or from 50 to 200 mPa·s. A desired molecular weight M_{w} is preferably from about 50,000 to about 1,000,000 or higher, for example from about 100,000 to about 1,000,000. A desired molar ratio of N-halohydrin groups to 3-hydroxyazetidinium groups of the polyamine-epihalohydrin resin is preferably low and may, for example, be from 0:1 to 0.5:1, such as from 0:1 to 0.3:1, from 0:1 to 0.2:1 or from 0:1 to 0.1:1. In some cases it is also possible to control the degree of reaction by monitoring the inorganic halogen content, which preferably is at least 50 mole % or at least 60 mole %, particularly at least 70 mole %, based on the total halogen content of the resin.

The process of converting a polyamine-epihalohydrin resin precursor into a polyamine-epihalohydrin resin using an alkaline material as described above may result in the formation of ash material, such as sodium sulphate (Na₂SO₄), sodium chloride (NaCl) or mixtures thereof in the resin product. The ash material may, for example constitute from about 1 to about 4 wt. % of the resin product. What ash material is formed may depend on what acid(s) and base(s) are used in the preparation of the resin precursor and the conversion thereof into the resin product. The exact amount of ash material formed may depend on the respective amounts of acid and base added and/or the pH. The amount of ash material may also depend on the solids content of the resin product.

After conversion of the polyamine-epihalohydrin resin precursor to a high performance polyamine-epihalohydrin resin, the resin may be stabilised by the addition of an acid. The acid added may be as described above for the production of the polyamine-epihalohydrin resin precursor. For example, when the desired viscosity is reached after addition of an alkaline material and optionally heating, an acid may be added, optionally with cooling. The pH of the final resin product may thus be lowered to a value in the range of from 2 to 5, preferably from 2.5 to 3.5.

Addition of an acid after conversion into the final resin product is particularly preferred in cases when the resin is not to be used immediately.

After acid stabilisation of the polyamine-epihalohydrin resin a composition is usually obtained and the solids content thereof may be adjusted to a value suitable for its intended use, preferably from about 15 to about 30 wt. %, or from about 20 to about 25 wt. %.

A polyamine-epichlorohydrin resin obtained by the conversion process may also be subjected to a halogen reducing process such as dechlorination. Any known processes can be used, such as ion exchange as described in WO 92/22601, electrodialysis as described in EP 0666242, enzyme treatment, or extraction with a supercritical fluid as described in WO 2007/004972.

The conversion process may be performed even after a long time storage or long distance shipping of the above described polyamine-epihalohydrin resin precursor according to the invention without significant negative effects on the performance of the final product. Moreover, the conversion of the precursor does not require advanced production equipment, nor the rigorous safety measures necessitated by the handling of epihalohydrin.

The polyamine-epihalohydrin resin obtained by the conversion of a polyamine-epihalohydrin resin precursor as described above is suitable for use as a papermaking additive, such as a wet strength agent, a retention agent, an anionic trash catcher, a creping agent, etc. It may also be used as a cross-linking agent for carboxylated polymers or resins such as those found in latices, glues etc., and as a emulsifying or dispersing agent. In most cases it is used in the form of an aqueous composition.

A further aspect of the invention relates to a process for production of paper comprising the steps of adding an alkaline material to a resin precursor as described above to form a polyamine-epihalohydrin resin as described above; providing a furnish comprising cellulosic fibres; adding said polyamine-epihalohydrin resin to said furnish; and forming paper from said furnish. The resin precursor, the polyamine-epihalohydrin resin, the alkaline material and the process conditions in general may be as described above. The paper may, for example, be paper for use in a tissue article.

### EXAMPLES

All polyamines used in the following examples were polyaminoamides produced by the reaction of diethylene triamine with adipic acid and had a molecular weight M_{w} around 1,000-5,000. All viscosities with a solid content of >50 wt % refer to Brookfield viscosity measured at 25° C. using a Brookfield RVDV-II+ viscometer with the RV-spindles 3 and 4 at 60 and 80 rpm. The other viscosity measurements with a solid content of around 21 wt % refer to a micro falling ball viscometer from Haake Type 001-1926 measured at 25° C. The commercial wet strength resin Eka WS320™ was used as a reference. Unless otherwise stated, all parts percentages refer to parts and percent by weight.

### Example 1

This example illustrates preparation of a polyamine-epichlorohydrin resin precursor P1.

To 561 g of an aqueous solution of polyaminoamide having a solids content of 61.6 wt %, 165 g of epichlorohydrin was added over 50 minutes at 20° C. during stirring in a double jacket reactor. After 21 hours of stirring at 20° C. the reaction mixture was diluted with water to 65 wt % solids content and the pH was adjusted with formic acid (9.6 ml, 85 wt %) and sulphuric acid (115 ml, 30 wt %) to pH 5.3. The resulting resin precursor was named P1 and had a solids content of 61.76 wt %. Samples of P1 were stored for 8 days at 8° C. and for 20 days at 25° C. and 40° C. The changes in viscosity and inorganic chlorine were monitored. The results are shown in Table 1 below:

TABLE 1

| | P1 stored at 8° C. | | | P1 stored at 25° C. | | | P1 stored at 40° C. | | |
|---|---|---|---|---|---|---|---|---|---|
| | Viscosity | | Inorganic | Viscosity | | Inorganic | Viscosity | | Inorganic |
| | mPa . s | | chlorine | mPa . s | | chlorine | mPa . s | | chlorine |
| | (25° C.) | | content | (25° C.) | | content | (25° C.) | | content |
| | at solids | | mmol/l | at solids | | mmol/l | at solids | | mmol/l |
| | content | | (61.8% | content | | (61.8% | content | | (61.8% |
| Day(s) | 61.8% | 21%¹⁾ | solids) | 61.8% | 21%¹⁾ | solids) | 61.8% | 21%¹⁾ | solids) |
| 1 | 1258 | — | 216 | 1054 | — | 315 | 1058 | — | 495 |
| 6 | 764 | — | 286 | 746 | — | 597 | n/a | — | 783 |
| 8 | 1120 | 10 | 322 | n/a | 9 | n/a | n/a | — | n/a |
| 11 | — | — | — | 980 | — | 704 | 1248 | — | 844 |
| 14 | — | — | — | 1014 | — | 736 | 1272 | — | 866 |
| 20 | — | — | — | 1530 | 10 | 758 | 1680 | 11 | 889 |

¹⁾The precursor has been diluted to 21 wt % for viscosity determination.

It appears that even after 20 days of storage at 40° C. the viscosity after dilution to 21 wt % was still fully satisfactory, which indicates high stability against chemical changes.

### Example 2

This example illustrates conversion of P1 into polyaminoamide-epichlorohydrin resins P2a and P2b.

(a) 267 g of the resin precursor P1 from Example 1 that had been stored for 20 days at 25° C. was diluted with water to a solids content of 21 wt %. The resin precursor was then heated to a temperature of about 60° C. at a rate of 3° C./10 minutes in a double jacket reactor with stirring. 9 ml of a 50 wt % caustic solution was added to the resin precursor in order to increase the pH to about 7.4. When a viscosity of 80-100 mPa·s at 25° C. was reached, about 27 ml of a 30 wt % H₂SO₄ solution was added to quench the reaction and in parallel the reaction mixture was cooled to 20° C. and adjusted with water to a solids content of 20 wt %. The final pH was 2.8. The product was named P2a.
(b) 278 g of the resin precursor P1 from Example 1 that had been stored for 8 days at 8° C. was diluted with water to a solids content 21 wt %. The resin precursor was then heated to a temperature of about 60° C. at a rate of 3° C./10 minutes. About 9.0 ml of a 50 wt % caustic solution was added to the resin precursor to increase the pH to about 7.5. When a viscosity of 80-100 mPa·s at 25° C. was reached, approximately 30 ml of a 30 wt % H₂SO₄ solution was added to quench the reaction. The resulting resin product was cooled to 20° C. and adjusted with water to a solids content of 20 wt %. The final pH was 2.8. The product was named P2b.

### Example 3

This example illustrates preparation of a polyamine-epichlorohydrin resin precursor P3.

To a double jacket reactor containing 653.36 g of polyaminoamide solution in water having a concentration of 55 wt %, 172.05 g of epichlorohydrin was added over 30 minutes at 20° C. while stirring the reaction mixture. The reaction mixture was allowed to react for 20 hours at 20° C. under continuous stirring. The pH of the mixture was about 8.6. Under stirring 12.5 g of formic acid (85 wt %) and 160.5 g of sulphuric acid (30 wt %) was added to the reaction mixture to adjust the pH. The resulting polyaminoamide-epichlorohydrin resin precursor had a pH of 5.5, a viscosity of about 1040 mPa·s and a solids content of 60.7 wt %. The product was named P3.

### Example 4

This example illustrates conversion of P3 into polyaminoamide-epichlorohydrin resin P4.

214.7 g of the resin precursor P3 of Example 3 which had been stored for 9 days at room temperature, had a pH of 4.7, a solids content of 60.7 wt % and a viscosity of about 1100 mPa·s, was used. To this resin precursor 405.5 g of water was added while stirring at a temperature of 20° C. to obtain a solids content of 21 wt % and a pH of about 4.5. Next, 24.8 g of a 50 wt % sodium hydroxide solution was added. The reaction mixture was stirred continuously and heated at a rate of 3° C./10 minutes until a temperature of 60° C. was reached. The reaction mixture was kept at 60° C. for 70 minutes at which point a viscosity of about 80-90 mPa·s was reached, and then 26.9 g of 30 wt % sulphuric acid was quickly added and cooling was initiated. The pH of the final product was 2.8, the active content (polyamine-epichlorohydrin content) was 17.6 wt %, the ash content was 3.6 wt %, and the viscosity was 105 mPa·s. The resin product was named P4.

P4 was stored for 11 days before being used in the wet strength performance test of Example 7.

### Example 5

This example illustrates preparation of a polyamine-epichlorohydrin resin precursor P5.

To a double jacket reactor containing 361.27 g of polyaminoamide solution in water having a concentration of 55 wt %, 95.13 g of epichlorohydrin was added over 30 minutes at 20° C. while stirring the reaction mixture. The reaction mixture was allowed to react for 20 h at 20° C. under continuous stirring. The pH of the reaction mixture was about 8.6. Under stirring 6.9 g of formic acid (85 wt %) and 79.6 g of sulphuric acid (30 wt %) was added to the reaction mixture to adjust the pH. The resulting polyaminoamide-epichlorohydrin resin precursor had a pH of 5.5, a viscosity of about 1000 mPa·s and a solids content of 60.7 wt %. This resin precursor was named P5. P5 was stored for 7 days at room temperature before being used in the wet strength performance test of Example 7.

### Example 6

This example illustrates conversion of P5 into polyaminoamide-epichlorohydrin resin P6.

202.7 g of P5 (Example 5) which had been stored for 2 hours at room temperature and which had a solids content of 60.7 wt % was used. To this resin precursor 381.8 g of water was added at a temperature of 20° C. to obtain a solids content of 21 wt % and a pH of about 5.2. Next, 21.7 g of a 50 wt % sodium hydroxide solution in water was added while stirring to increase the pH to 9.1. The reaction mixture was stirred and heated at a rate of 3° C./10 minutes to a temperature of 60° C. The reaction mixture was kept at 60° C. for about 35 minutes at which point a viscosity of approximately 90 mPa·s was reached. The reaction was quenched by fast addition of 34.2 g of sulphuric acid solution (30 wt %) and cooling was initiated. The final product had a pH of 2.65, an active content (polyamine-epichlorohydrin content) of 18.3 wt %, an ash content of 3.2 wt % and a viscosity of 130 mPa·s. The product was named P6.

P6 was stored for 7 days before being used in the wet strength performance test of Example 7.

### Example 7

Paper sheets containing polyamine-epichlorohydrin resin precursors and polyamine-epichlorohydrin resins made therefrom were prepared and tested for wet strength performance. Paper sheets containing a commercial wet strength resin (Eka WS 320™, Eka Chemicals, Sweden) were used as reference.

Test sheets of approximately 70 g/m² were prepared on a pilot paper machine (speed 2 m/min, capacity 2 kg/h).

The paper furnish consisted of a 40/40/20 blend of 40% bleached eucalyptus sulphate, 40% bleached birch sulphate and 20% bleached pine sulfate which had been beaten to a Schopper-Riegler freeness of 35° SR and having a consistency of 1.5% in the machine chest. The resins and the polyamine-epichlorohydrin resin precursors were fed into the paper machine after the stock dilution. Each resin or resin precursor to be tested was added at 0.6, 0.9 and 1.2% by active content (solid content minus inactive species such as inorganic salts), respectively, to the fibre furnish.

The stock temperature was 30° C. The stock consistency at the headbox amounted to 0.3% and the pH remained in the range of 7.2-7.5 for all products and concentrations were not adjusted. The temperatures of the cylinders in the drying section were adjusted to 70/80/95/110° C.

The final paper was cured for 30 minutes at 100° C. and then conditioned at 23° C. with a relative humidity of 50% for 2 hours before wet strength testing. Paper strips were soaked for 5 minutes at 23° C. in distilled water before breaking length determination on an ALWETHRON TH1® hydrodynamic tester (Gockel & Co. GmbH, Germany).

The test results are summarised in Table 2. The wet strength efficacy is expressed as the wet breaking length in km. The results show that the wet strength performance of resins made from the resin precursors according to the invention is essentially equal to that of a commercial product (Eka WS 320™), based on the active content.

TABLE 2

| | | Eka | | | P3 (resin precursor) | | | P4 | | |
|---|---|---|---|---|---|---|---|---|---|---|
| Test | zero | WS 320 ™ | | | stored 20 | | | (resin made from | | |
| agent | value | (reference) | | | days at 25° C. | | | P3) | | |
| Active content (wt %) | | 20.2 | | | 60.7 | | | 17.6 | | |
| Amount of active | | 0.6 | 0.9 | 1.2 | 0.6 | 0.9 | 1.2 | 0.6 | 0.9 | 1.2 |
| test agent added | | | | | | | | | | |
| to the furnish | | | | | | | | | | |
| (% by dry weight) | | | | | | | | | | |
| g/m² | 71.4 | 69.6 | 70.0 | 67.7 | 63.4 | 69.1 | 69.3 | 68.0 | 65.7 | 69.2 |
| Breaking length, | 0.22 | 2.65 | 3.01 | 3.26 | 1.18 | 1.29 | 1.39 | 2.61 | 3.03 | 3.26 |
| wet (km) | | | | | | | | | | |
| Breaking length, | 2.9 | 2.6 | 2.5 | 2.7 | 3.5 | 2.4 | 4.0 | 2.2 | 1.5 | 2.0 |
| wet (V %) | | | | | | | | | | |

| | P5 (resin precursor) | | | P6 | | |
|---|---|---|---|---|---|---|
| Test | stored 7 days at | | | (resin made from | | |
| agent | 25° C. | | | P5) | | |
| Active content (wt %) | 60.1 | | | 18.3 | | |
| Amount of active | 0.6 | 0.9 | 1.2 | 0.6 | 0.9 | 1.2 |
| test agent added | | | | | | |
| to the furnish | | | | | | |
| (% by dry weight) | | | | | | |
| g/m² | 67.6 | 66.9 | 68.8 | 68.3 | 68.1 | 67.9 |
| Breaking length, | 1.07 | 1.17 | 1.24 | 2.49 | 2.83 | 3.10 |
| wet (km) | | | | | | |
| Breaking length, | 2.9 | 2.9 | 1.8 | 1.5 | 2.3 | 2.0 |
| wet (V %) | | | | | | |

### Example 8

This example illustrates determination of chlorohydrin and azetidinium content of P3.

A sample of polyamine-epichlorohydrin resin precursor P3 was analysed at 1, 9, 15 and 23 days after preparation by ¹³C-NMR. The samples were stored in darkness at room temperature (−23° C.) between the analyses. Table 3 presents the mole % contents of N-chlorohydrin and 3-hydroxyazetidinium relative to the amount of adipic acid used for preparing the polyamine. The amount of unreacted epichlorohydrin was negligible, and therefore “chlorohydrin” refers to N-chlorohydrin. “Azetidinium” refers to 3-hydroxyazetidinium.

TABLE 3

| | Azetidinium | Chlorohydrin | Approx. molar ratio |
|---|---|---|---|
| Days after | (mole % relative | (mole % relative | of chlorohydrin to |
| preparation | to adipic acid) | to adipic acid) | azetidinium |
| 1 | 9.3 | 62.3 | 6.7 |
| 9 | 16.9 | 53.1 | 3.1 |
| 15 | 19.8 | 50.4 | 2.5 |
| 23 | 20.5 | 46.1 | 2.2 |

1. A polyamine-epihalohydrin resin precursor comprising, as functional groups:
N-halohydrin groups attached to a polyamine backbone, and
3-hydroxyazetidinium groups attached to a polyamine backbone, said resin precursor having a solids content exceeding 30 and up to 95 wt % and a molar ratio of N-halohydrin groups to 3-hydroxyazetidinium groups in the range of from 1:2 to 100:1, as determined by ¹³C-NMR.

2. The resin precursor according to claim 1, wherein said molar ratio of N-halohydrin groups to 3-hydroxyazetidinium groups is in the range of from 1:1 to 15:1.

3. The resin precursor according to claim 2, wherein said molar ratio of N-halohydrin groups to 3-hydroxyazetidinium groups is in the range of from 2:1 to 7:1.

4. The resin precursor according to claim 1, wherein the solids content is in the range of from 35 to 90 wt %.

5. The resin precursor according to claim 4, wherein the solids content is in the range of from more than 50 to 70 wt %.

6. The resin precursor according to claim 1, wherein said resin precursor has a pH in the range of from 3 to 7.

7. The resin precursor according to claim 6, wherein said resin precursor has a pH in the range of from 4 to 6.

8. The resin precursor according to claim 7, wherein said resin precursor has a pH in the range of from 4.5 to 5.5.

9. The resin precursor according to claim 1, wherein said N-halohydrin groups are N-chlorohydrin groups.

10. The resin precursor according to claim 1, wherein said 3-hydroxyazetidinium groups have a counter ion which is chloride, hydroxide or a combination thereof.

11. A process for the production of a polyamine-epihalohydrin resin precursor comprising the steps of:
(i) reacting a polyamine and epihalohydrin to obtain a reaction product comprising, as functional groups:
N-halohydrin groups attached to a polyamine backbone, and
3-hydroxyazetidinium groups attached to a polyamine backbone; and
(ii) adding at least one acid to said reaction product when said reaction product has attained a molar ratio of N-halohydrin groups to 3-hydroxyazetidinium groups in the range of from 1:3 to 100:1.

12. The process according to claim 11, wherein said at least one acid is added to the reaction product in an amount sufficient to reach a pH from 3 to 7.

13. A process for the production of a polyamine-epihalohydrin resin, the process comprising adding an alkaline material to the polyamine-epihalohydrin resin precursor according to claim 1.

14. The process according to claim 13, further comprising a step of heating said resin precursor to a temperature in the range of from 40 to 90° C. before and/or after said step of adding an alkaline material.

15. The process according to claim 13, further comprising a step of stabilizing the polyamine-epihalohydrin resin formed by addition of an acid to achieve a pH of from 2 to 5, wherein the addition of acid takes place after adding the alkaline material to the resin precursor.

16. The process according to claim 13, wherein the produced polyamine-epihalohydrin resin has a molar ratio of N-halohydrin groups to 3-hydroxyazetidinium groups in the range of from 0:1 to 0.2:1, as determined by ¹³C-NMR.

17. A process for the production of paper comprising the steps of
adding an alkaline material to the resin precursor according to claim 1 to form a composition comprising polyamine-epihalohydrin resin;
providing a furnish comprising cellulosic fibres;
adding said composition comprising polyamine-epihalohydrin resin to said furnish; and
forming paper from said furnish.

18. The resin precursor according to claim 4, wherein said resin precursor has a pH in the range of from 3 to 7.

19. The resin precursor according to claim 6, wherein said N-halohydrin groups are N-chlorohydrin groups.

20. The process according to claim 14, further comprising a step of stabilizing the polyamine-epihalohydrin resin formed by addition of an acid to achieve a pH of from 2 to 5, wherein the addition of acid takes place after adding the alkaline material to the resin precursor.
